(19) United States
(12) Patent Application Publication
(10) Pub. No.: US 2010/0002427 A1
(43) Pub. Date: Jan. 7, 2010

(54) Illuminating Device Comprising a Lamp and a Reflector

(76) Inventors: Franz Bachmeir, Petersdorf (DE); Martin Beck, Augsburg (DE); Ulrich Biebel, Rennertshofen (DE); Jürgen Dichtl, Augsburg (DE); Roland Hoffmann, Erben (DE); Maria Hoffmann, Augsburg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/514,259

(22) PCT Filed: Nov. 6, 2007
(86) PCT No.: PCT/EP2007/061950

§ 371 Date: May 8, 2009

(30) Foreign Application Priority Data
Nov. 8, 2006 (DE) 10 2006 052 756.9

(51) Int. Cl. F21S 4/00; F21V 1/00; F21V 9/16

(52) U.S. Cl. 362/225; 362/235; 362/84

(57) ABSTRACT

A lighting device with at least one lamp and at least one reflector, wherein at least regions of a reflective surface of the reflector are in the form of an involute of a circle of a partial element of the lamp.

### TECHNICAL FIELD

The invention relates to a lighting device with a lamp and a reflector

### PRIOR ART

For display backlights it is necessary to be able to provide lighting devices with a relatively flat design. Either relatively expensive flat lamps such as PLANON® by OSRAM GmbH, for example, or plasma screens are required for this purpose. When using tubular fluorescent lamps, however, it is necessary to set a relatively large distance in relation to the diffusing and reflector elements in order to be able to achieve the sufficient light homogenization. As a result, a lighting device with tubular fluorescent lamps with the configurations known to date are relatively space-intensive and voluminous. Backlights for LCD (liquid crystal display) TVs (backlight units, BLU) require a very high degree of luminance homogeneity.

### DESCRIPTION OF THE INVENTION

The object of the present invention is to provide a lighting device which can be designed so as to be optimized in terms of installation space and ensures a very high degree of luminance homogeneity when used as backlighting.

The object is achieved by a light device which has the features as claimed in patent claim 1.

A lighting device according to the invention comprises at least one lamp and at least one reflector. At least regions of a reflective surface of the reflector are in the form of an involute of a circle of the lamp. Owing to the configuration in terms of design of the reflector, a substantially smaller configuration can be made possible in comparison with conventional lighting devices in relation to the installation space. Furthermore, this specific configuration of the reflector makes it possible to achieve a very high degree of luminance homogeneity, which at least corresponds to the luminance homogeneity of conventional lighting devices. This therefore can allow for a particularly flat configuration with very good homogeneity of the surface brightness for display backlights and as an attractive flat light source with a high radiated power.

Preferably, the lamp comprises a phosphor layer, and at least regions of the reflective surface of the reflector are in the form of an involute of a circle of the phosphor layer. The surface of each lamp is quasi developed optically completely onto the reflective surface. The reflective surface of the reflector describes a precisely limited part of an involute of a circle, which is preferably designed such that it is not the outer side of a lamp bulb of the lamp which defines this development, but an inner phosphor layer. This makes guidance of radiation possible which consequently circumvents the lamp, i.e. in this case no losses occur as a result of the lamp itself.

Particularly preferably, the lamp is tubular. In particular, a fluorescent lamp can be provided which has a tubular discharge vessel. The lamp is preferably substantially in the form of an oblong bar, in particular the discharge vessel of the discharge lamp having a linear tube shape. This configuration comprises the lighting device with a lamp which is highly efficient for backlighting. The distances in relation to diffusing and reflector elements which are required for light homogenization are no longer necessary, or at most now only necessary to a reduced extent, owing to the configuration of the lighting device according to the invention in comparison with the prior art with such fluorescent lamps.

At least regions of the lamps of the reflector are covered on a light exit side of the lighting device by a transparent element. The transparent element can preferably be a diffuser, which can be formed, for example, from a plurality of foils. The diffuser preferably also comprises a spectral and/or polarizing filter function. Preferably, this transparent element is planar and is in the form of a display. The involute shape corresponds to a development of the lamp surface, in particular of the phosphor layer, with that part of the lamp surface which faces away from the transparent element, in particular the display, being projected completely homogeneously onto the front side of the display.

Preferably, the transparent element is arranged in such a way that the installation height of the arrangement comprising the reflector, the lamp and the transparent element is less than 1.5 times, in particular less than 1.3 times, in particular 1.26 times, the diameter of the lamp. The required reflector height and therefore the installation height of the lighting device is thus substantially smaller than in the case of conventional lighting devices with corresponding lamps. The reflector width corresponds conceptionally in particular precisely to the inner lamp circumference.

The illuminated exit surface of the reflector has at least the same luminance, homogeneity and radiation intensity as the lamp surface itself. Thus, in particular when using modern T16 lamps, efficiencies of more than 33 cd/W and luminous efficiencies of, for example, 10000 lm/m² can be achieved. In such an exemplary embodiment, the installation height is then only less than 23 mm.

It has proven to be particular preferred if at least regions of the reflective surface are formed so as to be symmetrical with respect to an axis through the starting point of the involute of a circle with the lamp. As a result of such a completely symmetrical development, a substantially loss-free and homogeneous optical unrolling of the lamp surface onto the measurement plane or onto a transparent plane of the lighting device can be achieved.

Preferably, the entire reflective surface of the reflector is substantially in the form of an involute of a circle of the lamp, in particular of the lamp surface and preferably of the phosphor layer, which is arranged on an inner side of the lamp bulb.

The reflector may be in the form of a reflected-light reflector. In such a configuration, a gap is formed between the reflective surface of the reflector and the lamp which is generally provided by an air space.

However, provision may also be made for the reflector to be formed as solid material, into which at least regions of the lamp are embedded. As a result, the reflector can be in the form of a solid element. For example, provision can be made for acrylic glass to be formed as the solid material. In particular, it is advantageous when a rear side of the reflector is metal-coated and forms the reflective surface. Such an embodiment makes it possible to ensure very precise and positionally accurate arrangement of the lamp.

Provision may also be made for a relatively small free space to be formed between the outer side of a lamp bulb of the lamp and the reflector material given such a configuration of the reflector from a solid material. Preferably, this very small free space is filled with a liquid, which is preferably highly transparent. In particular, provision may be made for silicone oil to be contained in this narrow slot-like free space.

Provision is preferably made for the entire outer side of the lamp bulb to be covered or surrounded by the liquid, in particular the silicone oil.

Preferably, at least regions of the lamp, in particular the region of the lamp bulb, are cast into the solid material and bears directly against the solid material. This configuration makes it possible to once again improve the positionally accurate arrangement of the lamp and to ensure a mechanically stable configuration. Owing to the fact that the lamp bears directly against the solid material, light coupling and light reflection can also be advantageously influenced. Preferably, a highly transparent and very refractive medium is provided as the solid material, with the reflector being formed by the surface thereof, partially as a result of loss-free total reflection.

Provision may be made for the lamp to be arranged on the side facing away from the reflector and therefore the side facing the transparent element, at a relatively short distance from this transparent element. For example, this distance is less than 4 mm, in particular less than 3 mm and preferably 2 mm. However, provision may also be made for the outer side of the lamp to be in direct mechanical contact with the transparent element. This configuration also makes it possible to achieve a cooling effect of the lamp during operation in addition to maximum minimization of the installation space with respect to the installation height, since the transparent element can be used for heat dissipation. Furthermore, the lamp is operated at maximum efficiency.

The reflector can be formed, for example, from a highly reflective aluminum. Preferably, provision is made for such a reflector to be inserted into a fixing element. This fixing element is arranged on the rear side of the reflector and is shaped correspondingly for the insertion of the fixing element. In particular, the fixing element may be in the form of a plastic shaped part, for example an injection-molded part. This makes it possible to ensure insertion with a precise fit and a dimensionally stable arrangement of the reflector. Owing to the configuration of the fixing element made from plastic, a relatively low-weight element can furthermore also be provided.

At least regions of the reflector can also be formed from plastic and have a reflective layer as the reflective surface. In particular, the reflector is likewise embodied as an injection-molded part, as a result of which it is also possible to achieve a reduction in weight. For example, a metal surface can be provided as the reflective layer on such a plastic reflector. This metal surface can be applied, for example, by means of an electroplating process.

In a particularly preferred manner, the lighting device comprises at least two lamps, which are preferably arranged spaced apart from one another. Each of these lamps has an associated, dedicated reflector, at least regions of which are in the form of an involute of a circle of the respectively associated lamp. Preferably, the at least two lamps are tubular and extend parallel to one another. It is thus possible to provide lighting devices which can also be provided for backlighting relatively large display arrangements with a very high degree of luminance homogeneity.

The reflectors associated in each case with the individual lamps can be provided as separate components. However, provision may also be made for this plurality of reflectors to be in the form of an integral element.

In the case of such a configuration of a lighting device with a plurality of lamps and a plurality of reflectors, the mutually facing end regions of the reflectors have a shorter installation height than the end regions which face away from one another. The shape of the transitions between the individual reflectors represents a critical point and can be improved by this configuration.

In a particularly preferred manner, an optical element is arranged on the mutually facing end regions of the reflectors. The light reflections at these critical points can thereby be favored to the extent that the homogeneity of the luminance between the individual reflectors, which in particular are arranged parallel, also increases. Differences in color between the individual lamps are virtually completely eliminated by lengthy mixing. This configuration with an optical element at the transition region also makes it possible to dispense with a DBEF polarization film of the display. In a configuration without such an optical element in the transition region between the two reflectors, this DBEF polarization film is preferably provided in particular when CCFL (cold cathode fluorescent lamps) are used as the lamps.

The optical element is preferably positioned on a front side of the end regions. The front side is particularly formed so as to face the transparent element of the lighting device and is formed so as to be substantially parallel to the extent of this transparent element. As a result, a highly symmetrical configuration and arrangement of the optical element can also be achieved.

Preferably, the optical element and the reflectors are arranged so as to be flush with one another at the connecting regions. It has proven to be particularly advantageous if the optical element is a prism. The prism is preferably arranged at the end regions of the reflectors in such a way that, in cross section, a triangular or pyramidal attachment is formed on these end regions. As a result of the use of such an optical element, it is also possible for the installation height of the reflectors at these transition regions or at the mutually facing end regions of the reflectors to be reduced once again. As a result, the occurrence of differences in color on the transparent element of the lighting device can be reduced once again.

### BRIEF DESCRIPTION OF THE DRAWINGS

Exemplary embodiments of the invention will be explained in more detail below with reference to schematic drawings, in which:

FIG. 1 shows a schematic sectional illustration through a first exemplary embodiment of a lighting device according to the invention;

FIG. 2 shows a schematic sectional illustration of a second exemplary embodiment of a lighting device according to the invention;

FIG. 3 shows a schematic sectional illustration through a third exemplary embodiment of a lighting device according to the invention;

FIG. 4 shows a schematic sectional illustration through a fourth exemplary embodiment of a lighting device according to the invention; and

FIG. 5 shows a schematic sectional illustration of a fifth exemplary embodiment of a lighting device according to the invention.

### PREFERRED EMBODIMENT OF THE INVENTION

Identical or functionally identical elements have been provided with the same reference symbols in the figures.

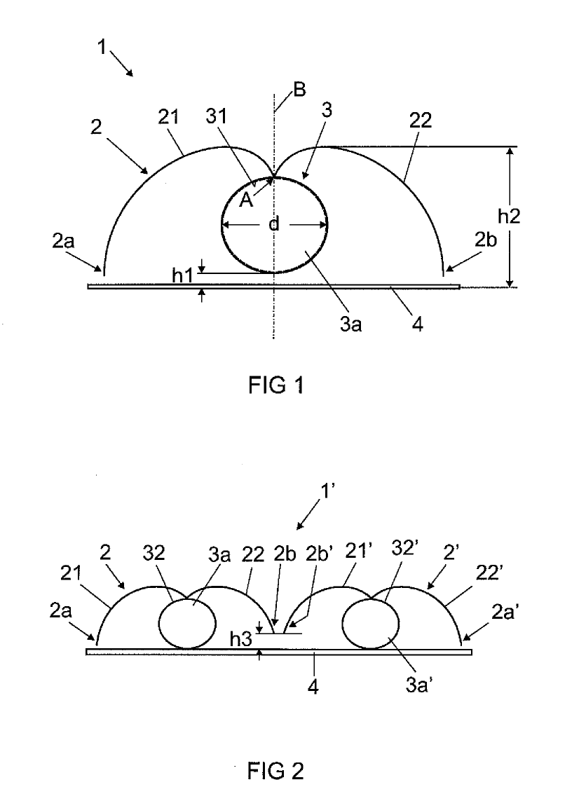

FIG. 1 shows, schematically, a section through a first exemplary embodiment of a lighting device 1. The lighting device 1 comprises a reflector 2 and a lamp 3. In the exemplary embodiment, the lamp 3 is in the form of a fluorescent lamp and comprises a rod-shaped, oblong and tubular discharge vessel. This discharge vessel and therefore also the lamp 3 extend perpendicular to the plane in the figure. Correspondingly, the reflector 2 extends perpendicular to the plane in the figure and substantially has a length which corresponds to the length of the lamp 3, in particular of the lamp bulb 3a or of the discharge vessel. Furthermore, the lighting device 1 which is in the form of an arrangement with a flat design comprises a transparent element 4, which is in the form of a display device or display. This transparent element 4 can be in the form of a diffuser and can comprise a plurality of foils. The transparent element 4 is formed so as to be substantially planar and likewise extends perpendicular to the plane in the figure.

The reflector 2 comprises reflective surfaces 21 and 22, which, in the exemplary embodiment, are substantially completely in the form of an involute of a circle of a phosphor layer 31, which is applied to the inner side of the lamp bulb 3a of the lamp 3. The reflective surfaces 21 and 22 are formed so as to be symmetrical with respect to an axis B through a starting point A of the involute of a circle on the lamp 3.

In the exemplary embodiment, the lamp 3 and therefore also the lamp bulb 3a is arranged on the side opposite the starting point A or contact point and therefore on the side facing the transparent element 4, at a height h1 away from this transparent element 4. In the exemplary embodiment, the distance h1 is approximately 2 mm. However, provision may also be made for the lamp 3 or the lamp bulb 3a to be in direct mechanical contact with the transparent element 4.

In the exemplary embodiment, the end regions 2a and 2b of the reflector 2 are arranged at a distance from the transparent element 4. The two end regions 2a and 2b in this configuration have a substantially equal distance from this transparent element 4.

The installation height h2 of the lighting device 1 shown in FIG. 1 is less than 2.5 cm. Furthermore, the dimensions of the reflector 2, the lamp 3 and the transparent element 4 are such that the installation height h2 is less than 1.3 times the diameter d of the lamp 3, in particular of the outer diameter d of the lamp bulb 3a. In the exemplary embodiment, this installation height h2 is only 1.26 times the outer diameter d of the lamp bulb 3a.

FIG. 2 shows a further exemplary embodiment of a lighting device 1′, which has at least two lamps 3 and 3′, which are formed in accordance with the configuration in FIG. 1 and extend parallel to one another. Furthermore, the lighting device 1′ comprises two reflectors 2 and 2′, which are associated with respective lamps 3 and 3′. As can be seen from the illustration in FIG. 2, the lamp bulbs 3a and 3a′ of the lamps 3 and 3′, respectively, are arranged in such a way that they are arranged with their outer sides 32 and 32′, respectively, directly on an inner side of the transparent element 4 on the regions facing the transparent element 4. The transparent element 4 is in the form of a cohesive planar structure.

The end regions 2a and 2a′ of the reflectors 2 and 2′, respectively, which end regions face away from one another, are formed at a smaller distance from the transparent element 4 than the mutually facing end regions 2b and 2b′, which, in comparison therewith, have a greater distance h3 with respect to the transparent element 4.

The reflective surfaces 21′ and 22′ of the reflector 2′ are likewise formed so as to be symmetrical with respect to an axis B running through the lamp 3′, corresponding to the configuration of the reflective surfaces 21 and 22 and the more detailed explanation in FIG. 1.

Provision may be made for the two reflectors 2 and 2′ to be in the form of separate elements and to be fastened in the form of rails on the corresponding fastening regions on the rear sides facing away from the reflective surfaces 21 and 22 and 21′ and 22′ In this case, for example, a screw-type connection on rail guides can be provided. In principle, however, any other mechanical fastening may also be provided. For example, latching or suspension in corresponding lug elements may be provided. The fixing rails can be formed from plastic, for example, and can therefore be manufactured as an injection-molded part. This makes relatively inexpensive and low-complexity production possible and makes it possible to achieve a reduction in weight of the entire system.

In the exemplary embodiment, the two reflectors 2 and 2′ are connected to one another at the mutually facing end regions 2b and 2b′.

Provision may also be made for the two reflectors 2 and 2′ to be in the form of an integral element.

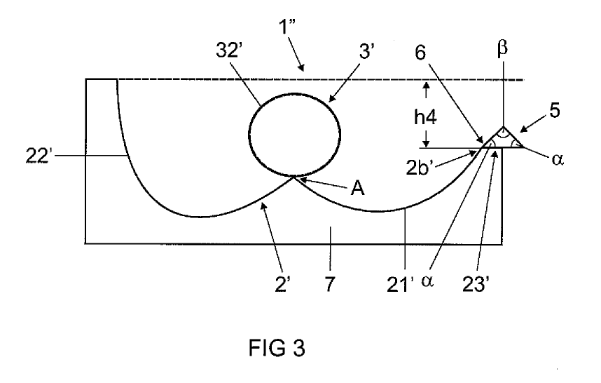

FIG. 3 shows a further sectional illustration of an exemplary embodiment of a lighting device 1″. This lighting device 1″ also comprises at least two lamps 3 and 3′ and corresponding reflectors 2 and 2′, as is provided in the lighting device 1′ shown in FIG. 2. For reasons of clarity, the illustration shown in FIG. 3 shows a partial detail, in which neither the transparent element 4 nor the lamp 3 and the reflector 2 are shown. In contrast to the configuration shown in FIG. 2, an optical element 5 in the form of a prism is arranged at a transition region 6 in the case of the mutually facing end regions 2b and 2b′. The two end regions 2b and 2b′ are flattened on a side facing the transparent element 4 for this purpose, with the result that a front side 23′ is formed which extends substantially parallel to the transparent element 4. The optical element 5 is positioned on this front side 23′ and a correspondingly formed front side of the end region 2b in such a way that it is arranged flush at the connecting regions between the reflective surface 21′ and the prism side 51. A corresponding flush arrangement is formed between the optical element 5 and the reflective surface 22 of the reflector 2. The optical element 5 in the form of a prism is positioned in such a way that it is oriented with a point in the direction of the transparent element 4. The angles α of the prism formed in the transition region 6 can vary between 25 degrees and 60 degrees. This angular dimension of the angle α can therefore be formed in a situation-dependent manner and a manner which is dependent on the installation height h2 of a lighting device 1. The angle β is then predetermined depending on the setting of the angle α.

Provision may preferably be made for the optical element 5 to be adhesively bonded to the corresponding front sides 23′.

It can be seen from the illustration in FIG. 3 that the reflector 2′ is inserted into a fixing element 7. In the exemplary embodiment, this fixing element 7 is in the form of an injection-molded part and is shaped in such a way that the reflector 2′ can be inserted with a precise fit.

In a further embodiment, provision may be made for the reflector 2′ to likewise be formed from plastic and to be in the form of an injection-molded part. The reflective surfaces 21′ and 22′ are then preferably applied to this plastic part as the reflective layer. For example, in this case a metal layer which has been applied by electroplating can be provided as the reflective surface 21′ and 22′.

The embodiment shown in FIG. 3 furthermore makes it possible to achieve a situation in which the distance h3 between the transparent element 4 and the mutually facing end regions 2b and 2b′ can be increased to a distance h4. Owing to this gap and in particular owing to the optical element 5, the luminance homogeneity at this transition region 6 between the two lamps 3 and 3′ can be substantially improved. Differences in color between the individual luminous means are eliminated to a large extent by lengthy mixing and, when viewing the transparent element 4, can at most only be perceived very weakly and therefore in a manner which is virtually no longer disruptive or even cannot be perceived at all any more.

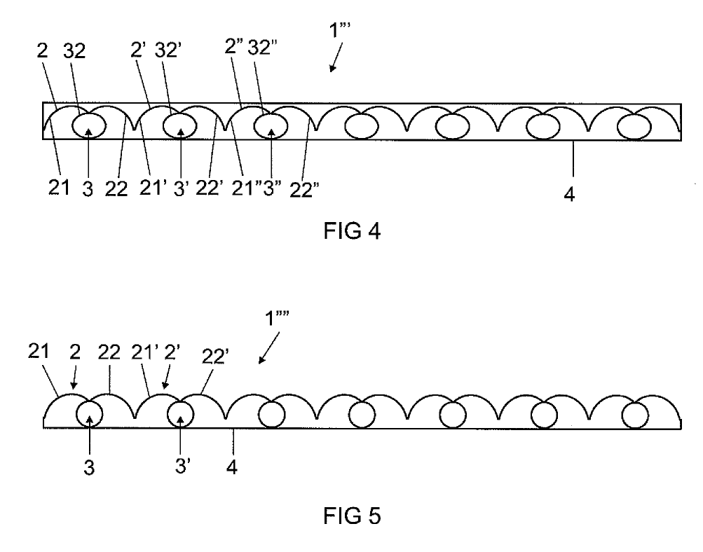

FIG. 4 shows a schematic sectional illustration of a further embodiment of a lighting device 1′″. This lighting device 1′″ comprises a plurality of lamps, of which only the lamps 3, 3′ and 3′″ will be described in more detail, by way of example. The associated reflectors 2, 2′ and 2″ with their corresponding reflective surfaces 21, 22, 21′, 22′, 21″ and 22″ are arranged in such a way that they are spaced apart from the outer sides 32, 32′ and 32″. There are therefore relatively large air spaces between these outer sides 32, 32′ and 32″ and the mentioned reflective surfaces.

FIG. 5 shows a further embodiment of a lighting device 1″″. In this case, too, the lighting device 1″″ comprises a plurality of lamps, of which again the lamps 3 and 3′ are described in more detail. In this embodiment of the lighting device 1″″, the reflectors 2, 2′, which are described in more detail in a manner which is representative of the remaining reflectors, are formed from a solid material. The lamps 3 and 3′ are arranged so as to be embedded in this solid material. The lamps 3 and 3′ are therefore surrounded by the solid material, which is acrylic glass as a highly transparent and very refractive medium in the exemplary embodiment. In particular, the respective lamp bulb of the lamps 3 and 3′ is surrounded by the solid material, apart from the region facing the transparent element 4.

In this configuration with a reflector 2, 2′ formed from solid material, the reflection of the light takes place at the reflective surfaces 21, 22 and 21′ and 22′, respectively, formed on the rear side. The reflection can in this case take place in particular by substantially loss-free total reflection at these rear reflective surfaces 21, 22 and 21′ and 22′ and therefore at the transition region to a further medium. These rear sides are preferably metal-coated.

Provision may be made for a very small split to be formed between an outer side of a lamp 3 and 3′ and the solid material of the reflector 2 and 2′, which split is in the form of a free space. Preferably, this free space is formed completely circumferentially around the outer region of a lamp bulb of a lamp 3 and 3′, with the result that a minimum distance between the solid material and this outer side is formed. Preferably, a highly transparent liquid can be introduced into this free space. In particular, silicone oil can be introduced here.

Provision may likewise be made for the lamps 3 and 3′ to be introduced into the solid material of the reflectors 2 and 2′ in such a way that the outer sides 32 and 32′ of the lamps 3 and 3′ are in direct mechanical contact with the solid material. Provision may preferably be made here for the lamps 3 and 3′ to be integrated in the solid material using manufacturing technology, for example to be cast into said solid material.

1. A lighting device with at least one lamp and at least one reflector, wherein
at least regions of a reflective surface of the reflector are in the form of an involute of a circle of a partial element of the lamp.

2. The lighting device as claimed in claim 1,
wherein
the lamp has a phosphor layer, and at least regions of the reflective surface of the reflector are in the form of an involute of a circle of the phosphor layer.

3. The lighting device as claimed in claim 1,
wherein
a lamp bulb of the lamp is tubular.

4. The lighting device as claimed in claim 1, wherein
the lamp bulb of the lamp is in the form of a substantially oblong bar.

5. The lighting device as claimed in claim 1, wherein
at least regions of the lamp and the reflector are covered on the light exit side of the lighting device by a transparent element.

6. The lighting device as claimed in claim 5,
wherein
the transparent element is arranged in such a way that the installation height of the arrangement comprising the reflector, the lamp and the transparent element is less than 1.5 times the diameter of the lamp.

7. The lighting device as claimed in claim 1, wherein
at least regions of the reflective surface are formed so as to be symmetrical with respect to an axis through the starting point of the involute of a circle and the lamp.

8. The lighting device as claimed in claim 1, wherein
the reflector is in the form of a reflected-light reflector.

9. The lighting device as claimed in claim 1, wherein
the reflector is formed as solid material, into which at least regions of the lamp are embedded.

10. The lighting device as claimed in claim 9,
wherein
a liquid is contained in a free space between the outer side of a lamp bulb of the lamp and the reflector.

11. The lighting device as claimed in claim 10,
wherein
the entire outer side of the lamp bulb is covered by the liquid.

12. The lighting device as claimed in claim 9,
wherein
at least regions of the lamp, are cast into the solid material and bears directly against the solid material.

13. The lighting device as claimed in claim 1, wherein
the reflector is inserted into a fixing element.

14. The lighting device as claimed in claim 1, wherein
at least regions of the reflector are formed from plastic and have a reflective layer as the reflective surface.

15. The lighting device as claimed in claim 1, wherein
at least two lamps arranged spaced apart from one another are formed, which lamps each have an associated reflector, at least regions of which are in the form of an involute of a circle of a partial element of the respectively associated lamp.

16. The light device as claimed in claim 15,
wherein
mutually facing end regions of the reflectors have a shorter installation height than the end regions which face away from one another.

17. The lighting device as claimed in claim 16,
wherein
an optical element is arranged on the mutually facing end regions of the reflectors.

18. The lighting device as claimed in claim 17,
wherein
the optical element is positioned on a front side of the end regions.

19. The lighting device as claimed in claim 17,
wherein
the optical element and the reflectors are arranged so as to be flush with one another at the connecting regions.

20. The lighting device as claimed in claim 15, wherein
the optical element is a prism.
